(19) United States
(12) Patent Application Publication
(10) Pub. No.: US 2015/0244227 A1
(43) Pub. Date: Aug. 27, 2015

(54) ROTARY ELECTRIC MACHINE

(71) Applicant: DENSO CORPORATION, Kariya-city (JP)

(72) Inventors: Toru WAKIMOTO, Chiryu-shi (JP); Yoshimitsu TAKAHASHI, Chiryu-shi (JP); Shinichi NINO, Kariya-shi (JP); Shinji KOUDA, Kariya-shi (JP)

(21) Appl. No.: 14/627,326

(22) Filed: Feb. 20, 2015

(30) Foreign Application Priority Data
Feb. 21, 2014 (JP) 2014-031840

(51) Int. Cl. H02K 3/28; H02K 3/12

(52) U.S. Cl. CPC H02K 3/28; H02K 3/12

(57) ABSTRACT

A rotary electric machine includes a rotor and a stator. A stator core has n in-phase slots provided in the circumferential direction and correspond to magnetic poles, and into each of which phase windings of the same phase are installed. Each of the phase windings is divided into 2n portions in an extending direction so that each of the phase windings is configured by a first partial winding, a second partial winding, . . . , and a 2n-th partial winding arranged from one end positioned in the extending direction in sequence. The first partial winding and the 2n-th partial winding are inserted into different in-phase slots of the stator core. Counted from one end positioned in the extending direction, the 2m-th (1≦m≦n) partial winding at an even-numbered position and the (2m−1)-th partial winding are inserted into different in-phase slots of the stator core.

### CROSS-REFERENCE TO RELATED APPLICATION

This application is based on and claims the benefit of priority from earlier Japanese Patent Application No. 2014-31840 filed Feb. 21, 2014, the description of which is incorporated herein by reference.

### BACKGROUND

1. Technical Field

The present invention relates to a rotary electric machine which is used as, for example, a traction motor or a generator for a vehicle.

2. Related Art

A rotary electric machine is known which includes a rotor and a stator. The rotor has plural pairs of magnetic poles arranged in the circumferential direction. The stator has a stator core and a stator winding. The stator core has a plurality of slots arranged in the circumferential direction and is disposed so as to be opposed to the rotor in the radial direction. The stator winding is configured by a plurality of phase windings which are inserted into the slots and are wound in the stator core. In such a rotary electric machine, to respond to a request to provide higher power, the stator core has n (which is a natural number of two or more) in-phase slots, which are consecutively provided in the circumferential direction so as to correspond to the magnetic poles. In each of the in-phase slots, the phase windings of the same phase are installed.

As shown in FIG. 11, JP-A-2013-81356 discloses a configuration in which each phase winding 41 is divided into 2n (4 when n=2) portions from one end (each phase output terminal 43) positioned in the extending direction to the other end (neutral point 44). In addition, a first partial winding a and a fourth partial winding d are inserted into different in-phase slots. Hence, resonance produced between the phase windings 41 of the stator winding is reduced to decrease the maximum voltage between the phase windings 41. Hence, phase-to-phase distances required for isolation can be shortened.

For example, to drive a motor (traction motor) by using an inverter, switching is required to be performed with high speed under, for example, PWM control. In this case, surge voltage, which is higher than the driving voltage, is generated at an input portion of the motor or between phases of the motor every time when switching. If a phase-to-phase voltage exceeds a predetermined value, so-called partial discharge, which is minute discharge, is caused between surfaces of the phase windings. When this state continues, a breakdown is eventually caused. Hence, the partial discharge is required to be prevented to ensure the isolation.

To prevent the partial discharge, an insulation film on the surface of the winding is required to be thickened. However, if the insulation film is thickened, a space factor of the winding inserted into the slot decreases, thereby decreasing the motor efficiency and increasing the rotary electric machine in size. In addition, although the voltage between the coils in the traction motor increases due to a resonance phenomenon in the traction motor, the maximum value of the voltage is determined based on an inverter switching speed and a resonance frequency and a gain peak value in the traction motor, and increases as the switching speed increases. Hence, to improve the efficiency of the inverter, the isolation of the motor cannot be ensured when the switching speed increases.

### SUMMARY

An embodiment provides a rotary electric machine which lowers the maximum voltage between phase windings when an inverter is switched with high speed to ensure both higher efficiency of the inverter (higher switching speed) and reliability of isolation.

An embodiment provides a rotary electric machine, including: a rotor which has plural pairs of magnetic poles arranged in a circumferential direction; and a stator which has a stator core and a stator winding, the stator core having a plurality of slots arranged in the circumferential direction, and being disposed so as to be opposed to the rotor in a radial direction, and the stator winding formed of a plurality of phase windings inserted into the slots and wound in the stator core. The stator core has n (which is a natural number of two or more) in-phase slots, which are consecutively provided in the circumferential direction so as to correspond to the magnetic poles, and into each of which the phase windings of the same phase are installed. Each of the phase windings is divided into 2n portions from one end positioned in an extending direction to the other end so that each of the phase windings is configured by a first partial winding, a second partial winding, . . . , and a 2n-th partial winding arranged from one end positioned in the extending direction in sequence. The first partial winding and the 2n-th partial winding are inserted into different in-phase slots of the stator core. Counted from one end positioned in the extending direction, the 2m-th (m is a natural number satisfying 1≦m≦n) partial winding at an even-numbered position and the (2m−1)-th partial winding are inserted into different in-phase slots of the stator core.

### BRIEF DESCRIPTION OF THE DRAWINGS

In the accompanying drawings:

FIG. 1 is a cross-section view, which is cut along in the axial direction of a rotary electric machine, according to a first embodiment;

FIG. 2 is an overall perspective view of a stator according to the first embodiment;

FIG. 3 is a diagram for explaining a state where conductor segments are inserted into slots of a stator core according to the first embodiment;

FIG. 4A is a perspective view for explaining a winding method of phase windings according to the first embodiment, seeing from the oblique above;

FIG. 4B is a plan view for explaining the winding method, seeing in the axial direction;

FIG. 4C is a development view for explaining the winding method, developing in the circumferential direction;

FIG. 5A is a connecting diagram of the phase windings configuring a stator winding according to the first embodiment;

FIG. 5B is a schematic diagram showing positions of U-phase partial windings inserted into two U-phase in-phase slots of the stator core according to the first embodiment;

FIG. 6A is a graph showing a result of voltage measurement in a first test, the graph being a voltage waveform at an output side of an inverter;

FIG. 6B is a graph showing the result of the voltage measurement in the first test, the graph showing potential difference between the phase windings of the stator windings according to the first embodiment and a first conventional example;

FIG. 7 is a diagram showing voltage measurement positions of the stator winding of the first test;

FIG. 8 is a graph showing results of measurement of a second test according to the first embodiment and the first conventional example;

FIG. 9 is a graph showing a relationship between a frequency and a resonance gain of a third test according to the first embodiment and the first conventional example;

FIG. 10 is a diagram showing two resonance paths generated in a motor in the third test;

FIG. 11A is a connecting diagram of phase windings configuring a stator winding in a conventional rotary electric machine; and

FIG. 11B is a schematic diagram showing positions of U-phase partial windings inserted into two U-phase in-phase slots of a stator core in the conventional rotary electric machine.

### DETAILED DESCRIPTION OF THE PREFERRED EMBODIMENTS

With reference to the accompanying drawings, hereinafter are described embodiments of the present invention. Throughout the drawings, components identical with or similar to each other are given the same reference numerals for the sake of omitting unnecessary explanation.

### First Embodiment

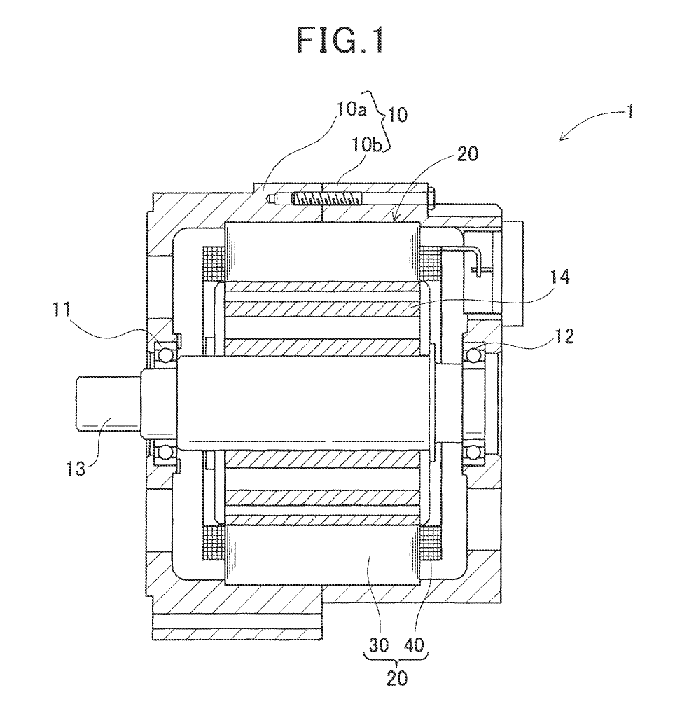

A rotary electric machine 1 according to the present embodiment is used as a motor for a vehicle (traction motor). As shown in FIG. 1, the rotary electric machine 1 includes a housing 10, a rotor 14, and a stator 20. The housing 10 is formed by joining opening portions of a pair of bottomed cylindrical housing members 10a, 10b to each other. The rotor 14 is fixed to a rotating shaft 13 rotatably supported to the housing 10 via bearings 11, 12. The stator 20 is fixed to the housing 10 so as to surround the rotor 14 in the housing 10.

The rotor 14 has plural pairs of magnetic poles arranged at outer circumference thereof, the outer circumference being opposed to the inner circumference of the stator 20 in the radial direction. The plural pairs of magnetic poles are arranged in the circumferential direction with predetermined distances therebetween, so that polarities of the magnetic poles adjacent to each other are different from each other. The magnetic poles are formed by a plurality of permanent magnets buried at predetermined positions of the rotor 14. The number of the magnetic poles of the rotor 14 differs between rotary electric machines. Hence, the number of the magnetic poles is not limited. In the present embodiment, an eight-pole (four N poles and four S poles) rotor is used.

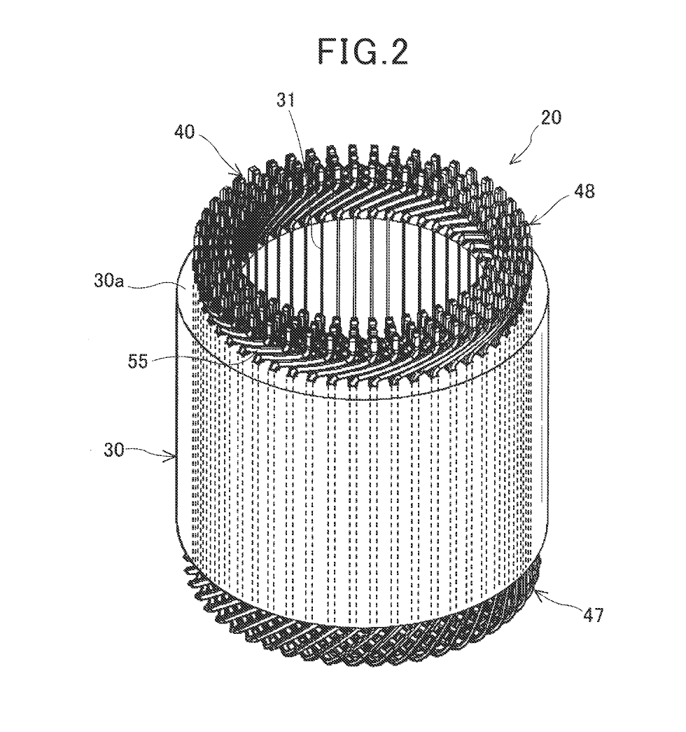

Next, the stator 20 is explained with reference to FIGS. 2 to 5. As shown in FIG. 2, the stator 20 includes an annular stator core 30 and a three-phase (U-phase, V-phase, W-phase) stator winding 40. The stator core 30 has a plurality of slots 31 arranged in the circumferential direction, and is disposed so as to be opposed to the rotor 14 in the radial direction. The three-phase stator winding 40 is wound in the stator core 30 in a state where end portions of open ends of a plurality of U-shaped conductor segments 50 inserted into the slots 31 are connected to each other by welding at one side of the stator core 30 in the axial direction.

The stator core 30 is configured by laminating a plurality of core sheets (steel sheets) in the axial direction. In the inner periphery of the stator core 30, the plurality of slots 31, each of which has a rectangular cross-sectional shape and penetrates the stator core 30 in the axial direction, are arranged at regular pitches in the circumferential direction and radially in the radial direction. The number of the slots 31 formed in the stator core 30 is two per phase of the stator winding 40 with respect to the number of the magnetic poles (eight) of the rotor 14. The slot multiple n (which is a natural number of two or more) is two. That is, in the stator core 30, two in-phase slots are consecutively provided in the circumferential direction so as to correspond to each of the magnetic poles. In each of the in-phase slots, the phase windings 41 of the same phase are installed. Hence, the number of the slots is 48 because 8×3×2=48.

The stator winding 40 wound through the slots 31 of the stator core 30 is configured by connecting end portions of open ends of the U-shaped conductor segments 50 to each other by welding. The conductor segment 50 is formed by bending a rectangular conductor, over the outer circumference of which an insulation film (not shown) is coated, in a U shape. Note that a joint part 56, which is formed by connecting the end portions of the conductor segments 50 by welding, has a conductor exposed portion (not shown) which is formed by peeling the insulation film.

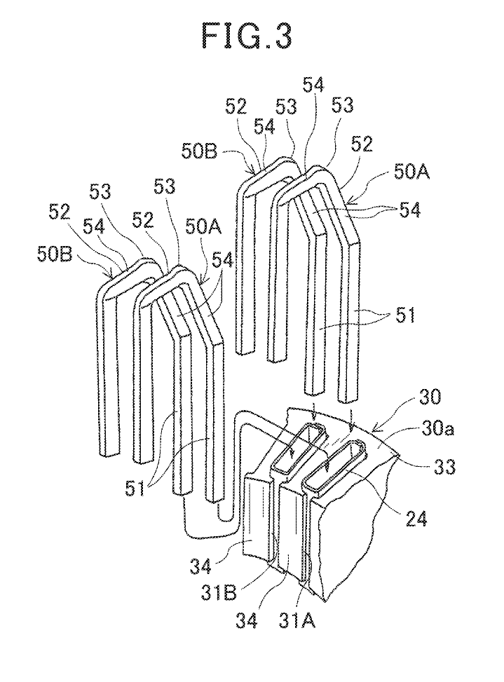

As shown in FIG. 3, the U-shaped conductor segment 50 includes a pair of linear portions 51, 51, which are parallel to each other, and a turn portion 52, which connects ends of the linear portions 51, 51 to each other. The central part of the turn portion 52 is provided with a top step portion 53 extending along an end face 30a of the stator core 30 and in parallel with the end face 30a. On the both sides of the top step portion 53, inclination portions 54 inclined at a predetermined angle with respect to the end face 30a of the stator core 30 are provided. Note that the reference numeral 24 indicates an insulator electrically insulating the stator core 30 and the stator winding 40 from each other.

FIG. 3 shows a pair of conductor segments 50A, 50B inserted into two slots 31A, 31B, which are adjacent to each other. In this case, the linear portions 51, 51 are not inserted into the same slot 31 but individually inserted into the two slots 31A, 31B, which are adjacent to each other, from one side of the stator core 30 positioned in the axial direction. That is, one of the linear portions 51 of one conductor segment 50A of the two conductor segments 50A, 50B, which are drawn on the right side of FIG. 3, is inserted into the outermost layer (sixth layer) of one slot 31A, while the other of the linear portions 51 is inserted into the fifth layer of another slot (not shown) distanced from the slot 31A by one magnetic pole pitch (NS magnetic pole pitch) in the counterclockwise direction of the stator core 30.

In addition, one of the linear portions 51 of the other conductor segment 50B of the two conductor segments 50A, 50B is inserted into the outermost layer (sixth layer) of the slot 31B adjacent to the slot 31A, while the other of the linear portions 51 is inserted into the fifth layer of another slot (not shown) distanced from the slot 31B by one magnetic pole pitch (NS magnetic pole pitch) in the counterclockwise direction of the stator core 30. That is, the two conductor segments 50A, 50B are arranged so as to be displaced by one slot pitch in the circumferential direction. Thus, the linear portions 51 of the conductor segments 50, the number of which is even, are inserted into the whole slots 31. In the case of the present embodiment, six linear portions 51 are inserted into the whole slots 31 so as to be laminated and arranged in a line and in the radial direction.

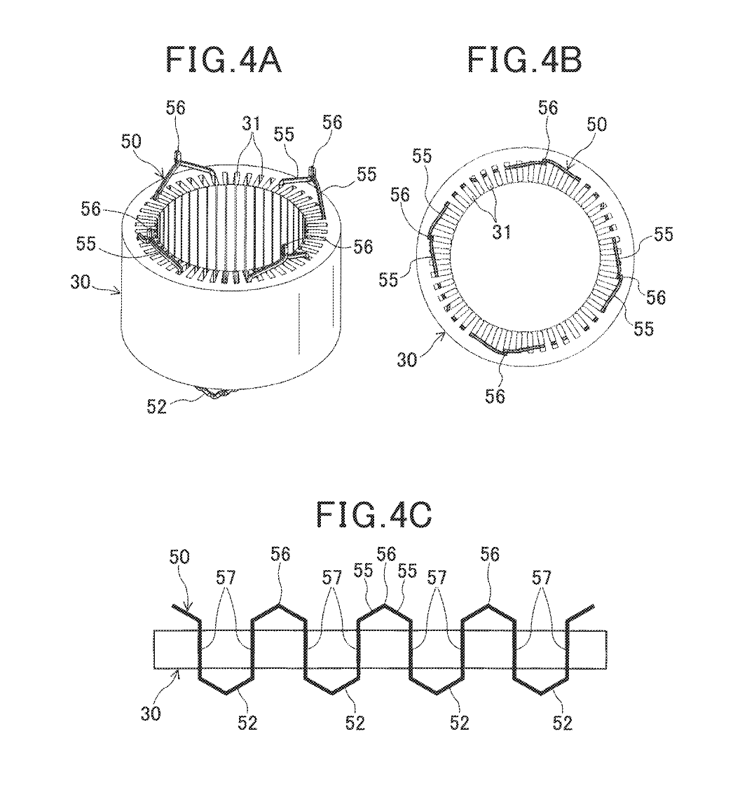

The open ends of the pair of linear portions 51, 51 extending from the slots 31 to the other side of the stator core 30 positioned in the axial direction are twisted in the direction opposed to the circumferential direction so as to incline a predetermined angle with respect to the end face 30a of the stator core 30. Thereby, an inclined portion 55 (see FIG. 2 and FIGS. 4A and 4B) is formed which has a length of substantially half a magnetic pole pitch. End portions of predetermined inclined portions 55 of the conductor segments 50 are joined to each other by welding (joint portions 56 in FIG. 4) so as to be electrically connected to each other with a predetermined pattern. That is, predetermined conductor segments 50 are connected in series to form the stator winding 40 having three phase windings (U-phase, V-phase, W-phase) 41 wound in a spiral form, that is, wave winding, in the circumferential direction and along the slots 31 of the stator core 30.

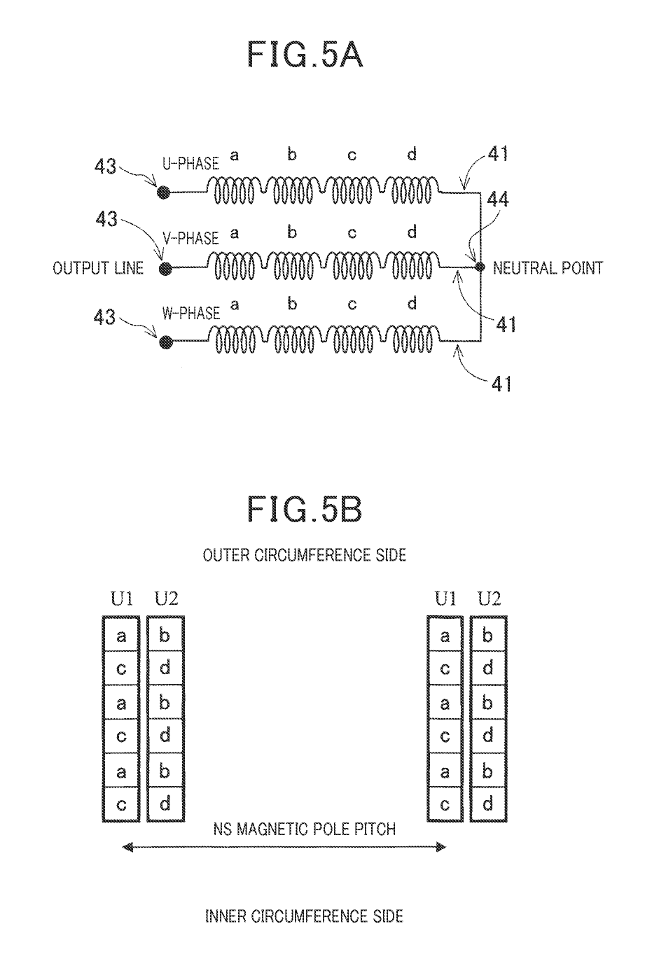

Note that, for each phase of the stator winding 40, a winding (coil) going around the stator core 30 six times is formed by basic U-shaped conductor segments 50. However, for each phase of the stator winding 40, a segment which integrally has a leading line for output and a leading line for a neutral point, and a segment which has a turn portion connecting the first turn and the second turn are configured by an irregular shape segment (not shown) which is different from the basic conductor segments 50. As shown in FIG. 5A, winding ends of the phases of the stator winding 40 are connected by star connection.

As shown in FIG. 2, one side (lower side in FIG. 2) of the stator winding 40, which is configured as described above, positioned in the axial direction is provided with a first coil end portion 47 in which the turn portions 52 of the conductor segment 50 projecting from one end face of the stator core 30 are laminated in the radial direction of the stator core 30. In addition, the other side (upper side in FIG. 2) of the stator winding 40 positioned in the axial direction is provided with a second coil end portion 48 in which the inclined portions 55 and the joint portions 56 (see FIGS. 4A and 4B) of the conductor segments 50 projecting from the other end face of the stator core 30 are laminated in the radial direction of the stator core 30.

As shown in FIG. 5A, each of the three phase windings (U-phase, V-phase, W-phase) 41 configuring the stator winding 40 is divided into 2n portions (four in the present embodiment, n=2) from the output terminal 43 of one end positioned in the extending direction to the neutral point 44 of the other end. Thereby, each of the three phase windings is configured by a first partial winding a, a second partial winding b, a third partial winding c, and a fourth partial winding d arranged from one end positioned in the extending direction in sequence. All the first to fourth partial windings a to d are wound in a spiral form.

In the present embodiment, as shown in FIG. 5B, the first partial winding a and the fourth partial winding d are inserted into different in-phase slots of the stator core 30. That is, the first partial winding a is inserted into one in-phase slot U1 of two adjacent in-phase slots U1, U2, and the fourth partial winding d is inserted into the other in-phase slot U2 of the two adjacent in-phase slots U1, U2. Note that, in FIG. 5B, the two in-phase slots U1, U2 of U-phase are shown as a typical example. The states of in-phase slots of V-phase and W-phase are similar to those of U-phase.

In a case of each of the phase windings 41, the 2m-th (m is a natural number satisfying 1≦m≦n) partial winding at an even-numbered position counted from the output terminal side, and the (2m−1)-th partial winding at an odd-numbered position prior to the 2m-th partial winding are inserted into different in-phase slots of the stator core 30. Specifically, as shown in FIG. 5B, the second partial winding b and the first partial winding a of the phase windings 41 are inserted into different in-phase slots. The fourth partial winding d and the third partial winding c of the phase windings 41 are inserted into different in-phase slots. That is, in the present embodiment, the first partial winding a and the third partial winding c are inserted into one in-phase slot U1 of the two adjacent in-phase slots U1, U2, and the second partial winding b and the fourth partial winding d are inserted into the other in-phase slot U2 of the two in-phase slots U1, U2.

Note that the in-phase slots, into which the first to fourth partial windings a to d of the phase windings 41 are inserted, can be changed by slightly modifying the connection of the connecting wire of the second coil end portion 48 of the stator winding 40 projecting outward from the other end face of the stator core 30 positioned in the axial direction. Hence, the stator 20 can be easily realized with preventing the performance of the motor from decreasing.

According to the rotary electric machine 1 of the present embodiment configured as described above, each of the phase windings 41 configuring the stator winding 40 is divided into 2n (4 when n=2) portions so as to be configured by the first to fourth partial winding a to d. The first partial winding a and the fourth partial winding d are inserted into the different in-phase slots U1, U2. The 2m-th partial winding at an even-numbered position counted from one end positioned in the extending direction and the (2m−1)-th partial winding are inserted into the in-phase slots U1, U2. Hence, since the peak value of the resonance gain in the rotary electric machine 1 can be lowered, the maximum voltage between the phase windings can be lowered when the inverter is switched with high speed. Hence, the efficiency of the inverter can be higher (switching speed can be higher), while the reliability of isolation can be ensured.

In addition, in the present embodiment, the slot multiple n is two. Each of the phase windings 41 is divided into 4 (2n) portions from one end positioned in the extending direction to the other end. In addition, the first and third partial windings a, c are inserted into one in-phase slot U1, and the second and fourth partial windings b, d are inserted into the other in-phase slot U2. Hence, the rotary electric machine in which the slot multiple n is set to two can reliably provide the above advantages.

In addition, in the present embodiment, since all the first to fourth partial windings a to d of the phase windings are wound in a spiral form, the stator winding 40 can be easily formed. In addition, resonance produced between the phase windings of the stator winding 40 can be reliably reduced.

In addition, the stator winding 40 is a segment type configured by the plurality of phase windings 41, which are formed by such a way in which the plurality of conductor segments 50, which are inserted into the slots 31 and in the axial direction, are connected in series and wound in the stator core 30. Hence, compared with a case where the stator winding 40 is configured by a continuous wire, the single conductor segment 50 is very short in length and easy to handle. Hence, the stator winding 40 can be easily manufactured.

### First Test

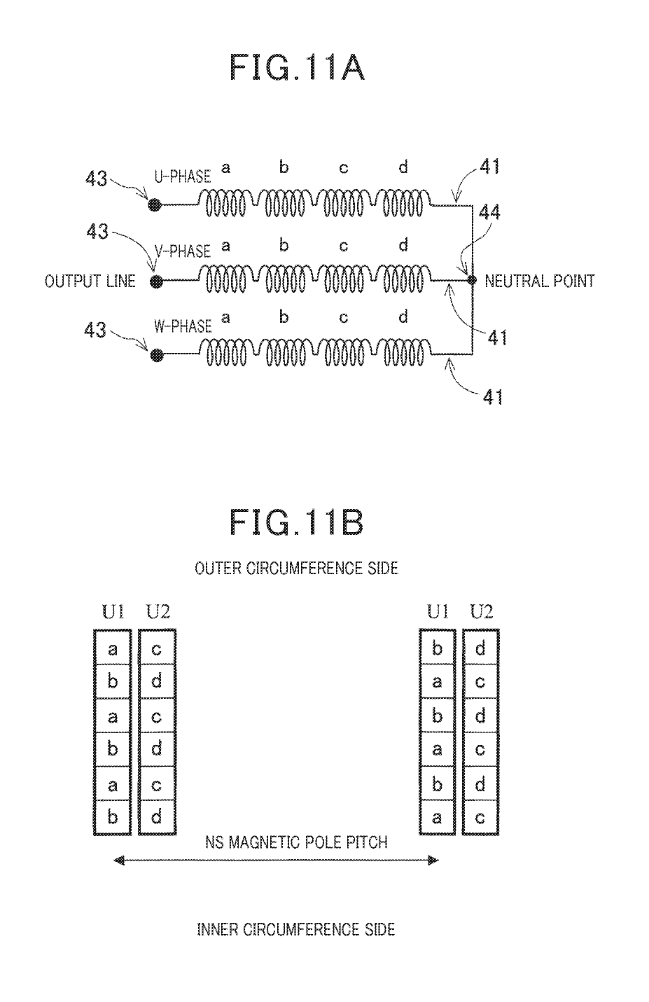

The first test has performed for motors (traction motors) manufactured by the winding method of the first embodiment and a winding method of a conventional example to compare the maximum potential differences between the phase windings when the inverter is switched. The conventional example is disclosed in JP-A-2013-81356. As shown in FIG. 11B, the first and second partial windings a, b are inserted into one in-phase slot U1 of two in-phase slots U1, U2, and the third and fourth partial windings c, d are inserted into the other in-phase slot U2 of the two in-phase slots U1, U2. The compared motors of the first embodiment and the conventional example are formed by different methods of arranging the partial windings a to d inserted into the in-phase slots. The compared motors have other similar configurations and similar performance (power, efficiency and the like).

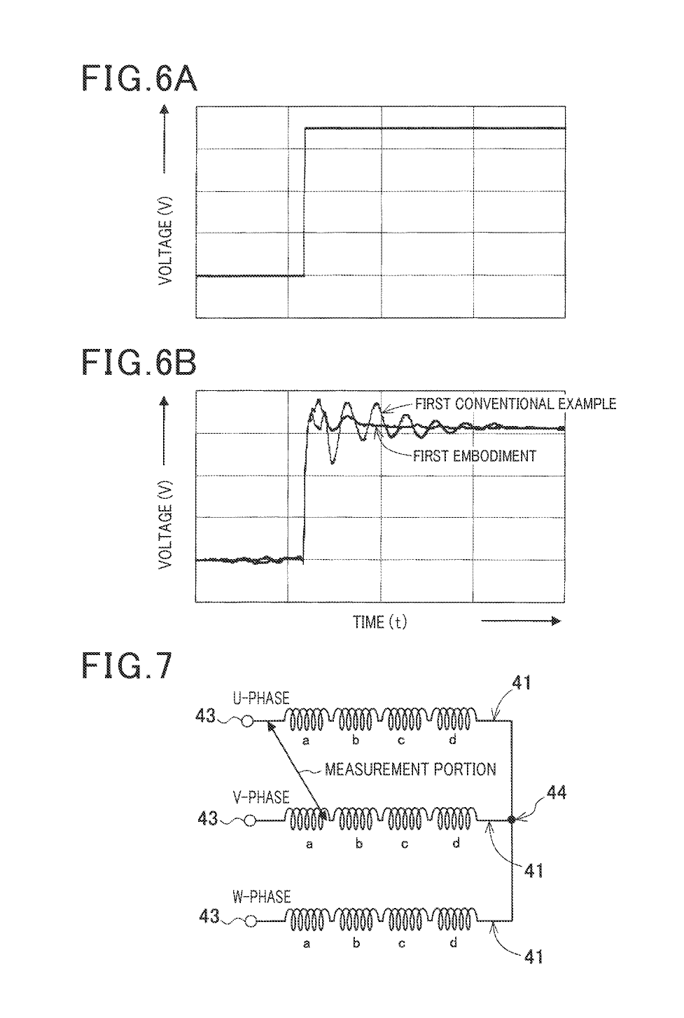

As shown in FIG. 7, the measurement of potential differences between the phase windings of the stator windings of the first embodiment and the conventional example is performed between the end of the input side of one of the phase windings (U-phase), where the voltage is maximized when the inverter is switched, and the connecting portion between the first partial winding a and the second partial winding b of the other of the phase windings (V-phase). The result is shown in FIG. 6B. Note that FIG. 6A shows a voltage waveform at an output side of the inverter. As is clear from FIG. 6B, the maximum potential difference between the phase windings of the first embodiment is lower than that of the conventional example.

### Second Test

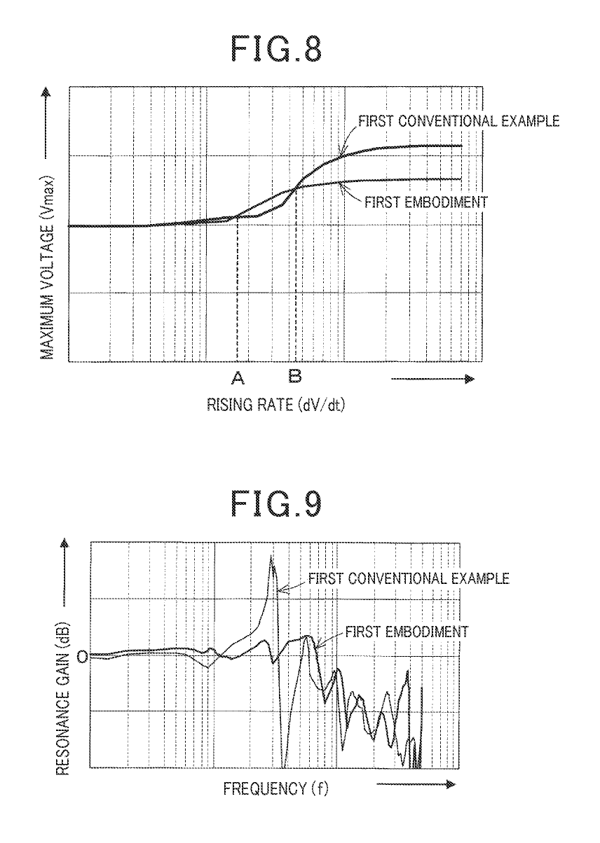

The second test has performed to compare the maximum potential differences between the phase windings when a rising rate of an output waveform of the inverter is varied, by using the motors of the first embodiment and the conventional example in the first test. The result of the second test is shown in FIG. 8.

As is clear from FIG. 8, in a region which is before point A and where the rising rate is lower, the maximum voltages of the first embodiment and the conventional example are substantially the same. In an intermediate region which is from point A to point B, the maximum voltage of the first embodiment is higher than the maximum voltage of the conventional example. In addition, in a region which is after point B and where the rising rate is higher, the maximum voltage of the conventional example is higher than the maximum voltage of the first embodiment. Hence, it is understandable that, when the switching speed of the inverter is higher, the maximum voltage between the phase windings in the first embodiment can be lower than that in the conventional example.

### Third Test

The third test is performed for the motors of the first embodiment and the conventional example used in the tests 1 and 2 to examine transfer characteristics between an output terminal of the inverter and an input terminal of the motor. The result of the third test is shown in FIG. 9. In FIG. 9, the region in which the resonance gain is 0 dB or more is an amplification region. Surge voltage is generated, which corresponds to a frequency and a gain in the amplification region, at the input terminal of the motor.

Specifically, as the maximum gain of the transfer characteristics increases, the surge voltage is amplified more greatly, thereby increasing the maximum surge voltage at the input terminal of the motor. In addition, the maximum surge voltage increases depending on gain characteristics in a high frequency region, as the switching speed of the inverter increases. That is, in the motor having characteristics in which the gain is higher in the high frequency region of the transfer characteristics, the surge voltage is amplified in a region where the switching speed (rate of increase of voltage) of the inverter is higher, and the maximum voltage at the input terminal of the motor also increases.

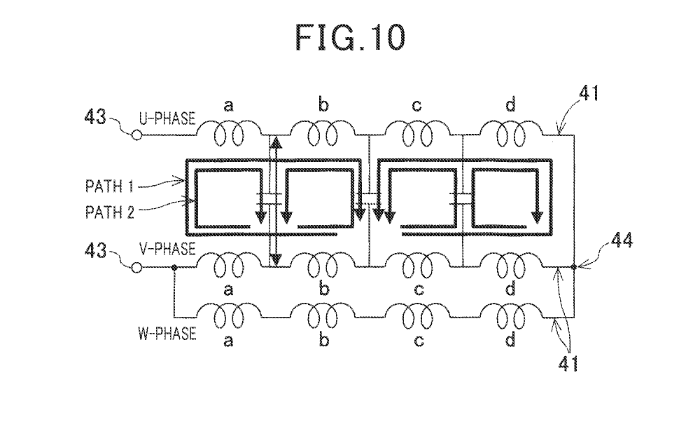

Comparing the transfer characteristics of the winding methods of the first conventional example and the first embodiment shown in FIG. 9 with each other, in the whole frequency region, the gain peak value of the winding method of the first embodiment is lower than that of the first conventional example. When the switching speed is higher, the winding method of the first embodiment can suppress the serge voltage compared with that of the first conventional example. This is because, as shown in FIG. 10, resonance between two paths, that is, a first path and a second path, is produced in the motor at the moment of switching, which causes the increase in the potential difference between the phase windings in the motor.

According to the winding method of the first embodiment, changing the order of connections makes a resonance current flow in the opposite directions between the two partial windings (a and c, b and d) inserted into the same in-phase slot to cancel mutual inductance. Hence, the inductance of the resonance path lowers. When a resonance Q factor is lowered, the resonance gain is lowered.

It will be appreciated that the present invention is not limited to the configurations described above, but any and all modifications, variations or equivalents, which may occur to those who are skilled in the art, should be considered to fall within the scope of the present invention.

### Other Embodiments

For example, although the conductor segments 50 having a U shape are used as basic members configuring the stator winding 40 in the first embodiment, conductor segments having an I shape may be used.

In addition, although n=2 (n is a natural number of two or more) in the first embodiment, n can be optionally set.

In addition, the first embodiment is an example in which a rotary electric machine according to the present invention is applied to a motor (traction motor). However, the present invention may be applied to a rotary electric machine, installed in a vehicle, which can be selectively used as a traction motor, a generator, or both the traction motor and the generator.

Hereinafter, aspects of the above-described embodiments will be summarized.

An embodiment provides a rotary electric machine, including: a rotor (14) which has plural pairs of magnetic poles arranged in a circumferential direction; and a stator (20) which has a stator core (30) and a stator winding (40), the stator core (30) having a plurality of slots (31) arranged in the circumferential direction, and being disposed so as to be opposed to the rotor in a radial direction, and the stator winding (40) formed of a plurality of phase windings (41) inserted into the slots and wound in the stator core. The stator core has n (which is a natural number of two or more) in-phase slots (U1, U2), which are consecutively provided in the circumferential direction so as to correspond to the magnetic poles, and into each of which the phase windings of the same phase are installed. Each of the phase windings is divided into 2n portions from one end positioned in an extending direction to the other end so that each of the phase windings is configured by a first partial winding (a), a second partial winding (b), . . . , and a 2n-th partial winding (d) arranged from one end positioned in the extending direction in sequence. The first partial winding and the 2n-th partial winding are inserted into different in-phase slots of the stator core. Counted from one end positioned in the extending direction, the 2m-th (m is a natural number satisfying 1≦m≦n) partial winding at an even-numbered position and the (2m−1)-th partial winding are inserted into different in-phase slots of the stator core.

According to the present embodiment, the first partial winding and the 2-th partial winding are inserted into different in-phase slots. The 2m-th (m is a natural number satisfying 1≦m≦n) partial winding at an even-numbered position counted from one end positioned in the extending direction and the (2m−1)-th partial winding are inserted into different in-phase slots of the stator core. Hence, changing the in-phase slots into which the partial windings of each of the partial windings are inserted can lower the peak value of the resonance gain in the rotary electric machine. Accordingly, the maximum voltage between the phase windings can be lowered when the inverter is switched with high speed. Hence, the efficiency of the inverter can be higher (switching speed can be higher), while the reliability of isolation can be ensured.

Note that the slots, into which the partial windings of each of phase windings are inserted, can be changed only by slightly modifying the connections of the connecting wires of the coil end portions of the stator winding projecting outward from the both end faces of the stator core positioned in the axial direction. Hence, the stator can be easily realized with preventing the performance of the motor from decreasing.

In addition, the switching speed of the inverter depends on the performance of power elements. However, since silicon carbide (SiC) elements, gallium nitride (GaN) elements and the like, which have been developed as next-generation elements, have promise for higher speed, the rotary electric machine is especially effective when driving the motor by using such elements.

What is claimed is:

1. A rotary electric machine, comprising:
a rotor which has plural pairs of magnetic poles arranged in a circumferential direction; and
a stator which has a stator core and a stator winding, the stator core having a plurality of slots arranged in the circumferential direction, and being disposed so as to be opposed to the rotor in a radial direction, and the stator winding formed of a plurality of phase windings inserted into the slots and wound in the stator core, wherein
the stator core has n (which is a natural number of two or more) in-phase slots, which are consecutively provided in the circumferential direction so as to correspond to the magnetic poles, and into each of which the phase windings of the same phase are installed,
each of the phase windings is divided into 2n portions from one end positioned in an extending direction to the other end so that each of the phase windings is configured by a first partial winding, a second partial winding, . . . , and a 2n-th partial winding arranged from one end positioned in the extending direction in sequence,
the first partial winding and the 2n-th partial winding are inserted into different in-phase slots of the stator core, and
counted from one end positioned in the extending direction, the 2m-th (m is a natural number satisfying 1≦m≦n) partial winding at an even-numbered position and the (2m−1)-th partial winding are inserted into different in-phase slots of the stator core.

2. The rotary electric machine according to claim 1, wherein
the stator core has the two in-phase slots, which are consecutively provided in the circumferential direction so as to correspond to the magnetic poles,
each of the phase windings is divided into four portions from one end positioned in an extending direction to the other end so that each of the phase windings is configured by the first partial winding, the second partial winding, a third partial winding, and a fourth partial winding arranged from one end positioned in the extending direction in sequence, and
the first and third partial windings are inserted into one in-phase slot of the two adjacent in-phase slots, and the second and fourth partial windings are inserted into the other in-phase slot of the two adjacent in-phase slots.

3. The rotary electric machine according to claim 1, wherein
all the first to 2n-th partial windings are wound in a spiral form.
